(19) United States
(12) Patent Application Publication
(10) Pub. No.: US 2026/0268867 A1
(43) Pub. Date: Sep. 10, 2026

(54) ELECTRONIC PAPER DISPLAY PANEL, DISPLAY APPARATUS AND DRIVING METHOD

(71) Applicants: Beijing BOE Technology Development Co., Ltd., Beijing (CN); BOE Technology Group Co., Ltd., Beijing (CN)

(72) Inventors: Zhichong WANG, Beijing (CN); Guangcai YUAN, Beijing (CN); Hua HUANG, Beijing (CN); Peng LIU, Beijing (CN); Jing FENG, Beijing (CN); Xin GU, Beijing (CN); Qian ZHANG, Beijing (CN)

(21) Appl. No.: 19/167,810

(22) PCT Filed: Apr. 17, 2024
(86) PCT No.: PCT/CN2024/088340

§ 371 Date: Sep. 22, 2025

(30) Foreign Application Priority Data
May 17, 2023 (CN) 202310558987.8

(51) Int. Cl. G09G 3/34; G02F 1/167; G02F 1/16766; G02F 1/1685

(52) U.S. Cl. CPC G09G 3/344; G02F 1/167; G02F 1/16766; G02F 1/1685; G09G 2310/0267; G09G 2310/0286

(57) ABSTRACT

An electronic paper display panel includes: a plurality of sub-pixels (2), each of which includes a first conduction circuit (10), a second conduction circuit (20) and a pixel electrode (3), herein the first conduction circuit and second conduction circuit in the same sub-pixel are both coupled to the pixel electrode, the first conduction circuit is configured to provide a reset signal from a reset signal end (RE) to the pixel electrode in response to a signal from a first control signal end (CS1), the second conduction circuit is configured to provide a data signal from a data signal end to the pixel electrode in response to a signal from a second control signal end (CS2), and the first conduction circuit and second conduction circuit in the same sub-pixel work in a time-sharing manner; and a gate driving circuit (30), which includes a plurality of shift registers (SR).

### CROSS REFERENCE TO RELATED APPLICATIONS

The application is a national phase entry under 35 U.S.C § 371 of International Application No. PCT/CN2024/088340, filed Apr. 17, 2024, which claims the priority to Chinese Patent Application No.202310558987.8, filed to the China National Intellectual Property Administration on May 17, 2023 and entitled “ELECTRONIC PAPER DISPLAY PANEL, DISPLAY APPARATUS AND DRIVING METHOD”, which is incorporated in its entirety herein by reference.

### TECHNICAL FIELD

The disclosure herein relates to the field of display technology and particularly relates to an electronic paper display panel, a display apparatus and a driving method.

### BACKGROUND

Electronic paper display products have effects of eye protection and power saving, thus attracting widespread attention. Among them, a non-capsule electrophoretic display structure has advantages in improving reflectivity, reducing response time, and improving grayscale capabilities.

The non-capsule electrophoretic display structure forms an electrophoretic liquid layer on a surface of a backplane, and then an upper glass substrate is covered with the electrophoretic liquid layer by vacuum cell bonding. The electrophoretic liquid in the electrophoretic liquid layer includes charged particles. By controlling electrodes located on both sides of the electrophoretic liquid layer to generate a vertical electric field, the aggregation degree of the charged particles at the bottom and top of the cell is adjusted to achieve different grayscales.

### SUMMARY

Embodiments of the disclosure provide an electronic paper display panel, including a plurality of sub-pixels and a gate driving circuit. Each of the plurality of sub-pixels includes a first conduction circuit, a second conduction circuit, and a pixel electrode; in a same sub-pixel, the first conduction circuit and the second conduction circuit are both coupled to the pixel electrode; the first conduction circuit is configured to provide a reset signal from a reset signal terminal to the pixel electrode in response to a signal from a first control signal terminal; the second conduction circuit is configured to provide a data signal from a data signal terminal to the pixel electrode in response to a signal from a second control signal terminal; and the first conduction circuit and the second conduction circuit in the same sub-pixel work in a time-division manner. The gate driving circuit includes a plurality of shift registers. The first control signal terminal corresponding to the first conduction circuit and the second control signal terminal corresponding to the second conduction circuit in the same sub-pixel are connected to different shift registers.

In some possible implementations, the first conduction circuit includes a first transistor. A gate of the first transistor is coupled to the first control signal terminal, a first electrode of the first transistor is coupled to the reset signal terminal, and a second electrode of the first transistor is coupled to the pixel electrode.

In some possible implementations, the second conduction circuit includes a second transistor. A gate of the second transistor is coupled to the second control signal terminal, a first electrode of the second transistor is coupled to the data signal terminal, and a second electrode of the second transistor is coupled to the pixel electrode.

In some possible implementations, the electronic paper display panel further includes a plurality of first scan signal lines and a plurality of second scan signal lines. First control signal terminals corresponding to a row of sub-pixels are all coupled to one of the plurality of first scan signal lines, second control signal terminals corresponding to the row of sub-pixels are all coupled to one of the plurality of second scan signal lines.

In some possible implementations, the plurality of shift registers includes: a plurality of first shift registers and a plurality of second shift registers. One of the plurality of first shift registers is coupled to one of the plurality of first scan signal lines, and one of the plurality of second shift registers is coupled to one of the plurality of second scan signal lines.

In some possible implementations, the plurality of shift registers includes: a plurality of third shift registers. One of the plurality of third shift registers is coupled to one of the plurality of first scan signal lines; the first scan signal line corresponding to the m^{th} row of sub-pixels is coupled to the second scan signal line corresponding to the n^{th} row of sub-pixels. m is greater than n; and both m and n are positive integers.

In some possible implementations, the electronic paper display panel further includes a plurality of reset signal lines and a plurality of data lines. Reset signal terminals corresponding to a column of sub-pixels are coupled to one of the plurality of reset signal lines; and data signal terminals corresponding to the column of sub-pixels are coupled to one of the plurality of data lines.

In some possible implementations, the electronic paper display panel further includes a plurality of gating control circuits and a plurality of source driving input terminals. The column of sub-pixels corresponds to one gating control circuit of the plurality of gating control circuits and one source driving input terminal of the plurality of source driving input terminals; the source driving input terminal is coupled to the reset signal line and the data line of the corresponding column of sub-pixels through the gating control circuit, and the gating control circuit is configured to provide a signal from the source driving input terminal to the reset signal line in response to a signal from a first gating control terminal, and to provide the signal from the source driving input terminal to the data line in response to a signal from a second gating control terminal.

In some possible implementations, the gating control circuit includes: a first gating control transistor and a second gating control transistor. A gate of the first gating control transistor is coupled to the first gating control terminal, a first electrode of the first gating control transistor is coupled to the reset signal line, and a second electrode of the first gating control transistor is coupled to the source driving input terminal. A gate of the second gating control transistor is coupled to the second gating control terminal, a first electrode of the second gating control transistor is coupled to the data line, and a second electrode of the second gating control transistor is coupled to the source driving input terminal.

In some possible implementations, the plurality of reset signal lines are coupled with each other.

In some possible implementations, the electronic paper display panel further includes a plurality of data lines and a plurality of source driving input terminals. A column of sub-pixels corresponds to one of the plurality of data lines and one of the plurality of source driving input terminals; and data signal terminals corresponding to the column of sub-pixels are coupled to the source driving input terminal through the data line.

In some possible implementations, the electronic paper display panel further includes a first base substrate. The plurality of sub-pixels are located at a side of the first base substrate. Each of the plurality of sub-pixels further includes a common electrode, located at a side of the pixel electrode facing away from the first base substrate; and an electrophoretic liquid layer, located between the pixel electrode and the common electrode, and the electrophoretic liquid layer including a plurality of charged particles. The pixel electrode is configured to drive the plurality of charged particles to adjust grayscale display.

The embodiments of disclosure provide a display apparatus including the above electronic paper display panel.

The embodiments of disclosure provide a method for driving the electronic paper display panel above, including: in a first stage, in response to the signal from the first control signal terminal, providing, by the first conduction circuit, the reset signal from the reset signal terminal to the pixel electrode; in a second stage, in response to the signal from the second control signal terminal, providing, by the second conduction circuit, the data signal from the data signal terminal to the pixel electrode. The first conduction circuit and the second conduction circuit in the same sub-pixel work in the time-division manner.

In some possible implementations, potentials of the reset signal and the data signal provided to the pixel electrode in the same sub-pixel are opposite to each other.

In some possible implementations, the potential of the reset signal provided to the pixel electrode in each of the sub-pixels is a fixed potential.

### BRIEF DESCRIPTION OF FIGURES

FIG. 1 is a schematic diagram of some structures of an electronic paper display panel provided by an embodiment of the disclosure.

FIG. 2 is another schematic diagram of some structures of an electronic paper display panel provided by an embodiment of the disclosure.

FIG. 3 is yet another schematic diagram of some structures of an electronic paper display panel provided by an embodiment of the disclosure.

FIG. 4 is yet another schematic diagram of some structures of an electronic paper display panel provided by an embodiment of the disclosure.

FIG. 5 is yet another schematic diagram of some structures of an electronic paper display panel provided by an embodiment of the disclosure.

FIG. 6 is yet another schematic diagram of some structures of an electronic paper display panel provided by an embodiment of the disclosure.

FIG. 7 is a flow chart of a method for driving an electronic paper display panel provided by an embodiment of the disclosure.

FIG. 8 is a timing diagram of some signals provided by an embodiment of the disclosure.

FIG. 9 is yet another schematic diagram of some structures of an electronic paper display panel provided by an embodiment of the disclosure.

FIG. 10 is yet another schematic diagram of some structures of an electronic paper display panel provided by an embodiment of the disclosure.

FIG. 11 is another timing diagram of some signals provided by an embodiment of the disclosure.

FIG. 12 is yet another schematic diagram of some structures of an electronic paper display panel provided by an embodiment of the disclosure.

FIG. 13 is yet another timing diagram of some signals provided by an embodiment of the disclosure.

FIG. 14 is yet another schematic diagram of some structures of an electronic paper display panel provided by an embodiment of the disclosure.

FIG. 15 is yet another timing diagram of some signals provided by an embodiment of the disclosure.

### DETAILED DESCRIPTION

In order to make the objectives, technical solutions and advantages of the embodiments of the disclosure clearer, the technical solutions of the embodiments of the disclosure are described clearly and completely below with reference to the drawings of the embodiments of the disclosure. Apparently, the described embodiments are some, not all, of the embodiments of the disclosure. In addition, the embodiments and the features in the embodiments of the disclosure can be combined with each other without conflict. Based on the described embodiments of the disclosure, all other embodiments obtained by those of ordinary skill in the art without inventive efforts fall within the protection scope of the disclosure.

Unless otherwise indicated, the technical or scientific terms used in the disclosure shall have the usual meanings understood by a person of ordinary skill in the art to which the disclosure belongs. The words “first”, “second” and the like used in the disclosure do not indicate any order, quantity or importance, but are only used to distinguish different components. The word “including” or “containing” and the like, means that an element or item preceding the word covers an element or item listed after the word and the equivalent thereof, without excluding other elements or items. The word “connection” or “coupling” and the like is not restricted to physical or mechanical connection, but may include electrical connection, whether direct or indirect.

It should be noted that the sizes and shapes of the figures in the drawings do not reflect true proportions and are only intended to illustrate the disclosure. And the same or similar reference numbers throughout represent the same or similar elements or elements with the same or similar functions.

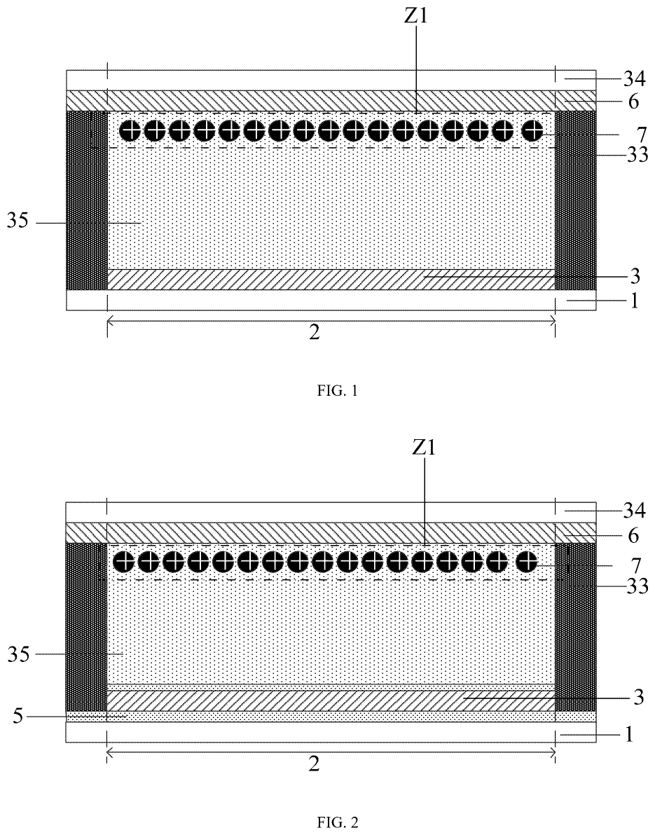

The embodiments of the disclosure provide an electronic paper display panel, as shown in FIG. 1, including: a first base substrate 1, and a plurality of sub-pixels 2. The plurality of sub-pixels 2 are located at a side of the first base substrate.

Each of the plurality of sub-pixels 2 includes: a pixel electrode 3; a common electrode 6 located at a side of the pixel electrode 3 facing away from the first base substrate 1; and an electrophoretic liquid layer 35 located between the pixel electrode 3 and the common electrode 6. The electrophoretic liquid layer includes a plurality of charged particles 7, and the pixel electrode 3 is configured to drive the plurality of charged particles 7 to adjust grayscale display.

In some possible embodiments, as shown in FIG. 1, the electronic paper display panel further includes: a second base substrate 34 located at a side of the common electrode 6 facing away from the first base substrate 1.

In a specific implementation, for example, a pixel electrode(s) can be formed on the first base substrate to obtain a first substrate; a common electrode(s) can be formed on a second base substrate to obtain a second substrate; an electrophoretic liquid layer is formed at a side of the first substrate, and then the second substrate is covered with the electrophoretic liquid layer by adopting a vacuum cell bonding process, to obtain the structure of the electronic paper display panel provided by the embodiments of the disclosure.

In a specific implementation, common electrodes of different sub-pixels are loaded with the same common electrode voltage, and by controlling the voltages loaded on the pixel electrodes to be not entirely the same, each sub-pixel presents the desired grayscale. Accordingly, in some embodiments, the common electrodes of a plurality of sub-pixels may be connected as a whole, that is, the common electrode is a planar electrode arranged over the entire surface on a side of the second substrate. In a specific implementation, for example, the common electrode is a transparent electrode, and a material of the common electrode includes indium tin oxide (ITO).

In some possible embodiments, in a direction perpendicular to the first base substrate, a distance between the pixel electrode and the common electrode is greater than or equal to 5 micrometers and less than or equal to 20 micrometers. For example, the distance between the pixel electrode and the common electrode may be 7 micrometers, 10 micrometers, or 15 micrometers.

In some possible embodiments, as shown in FIG. 2, the electronic paper display panel further includes: a second insulating layer 5 located between the pixel electrode 3 and the electrophoretic liquid layer 35. In the electronic paper display panel provided by the embodiments of the disclosure, the second insulating layer is further provided between the pixel electrode and the electrophoretic liquid layer, thereby preventing the contact between the charged particles and the pixel electrode, preventing the charged particles from being adsorbed and agglomerated at the pixel electrode to affect the display effect, and also preventing the pixel electrode from directly contacting the charged particles to cause electrochemical corrosion to affect the life of the electronic paper display panel.

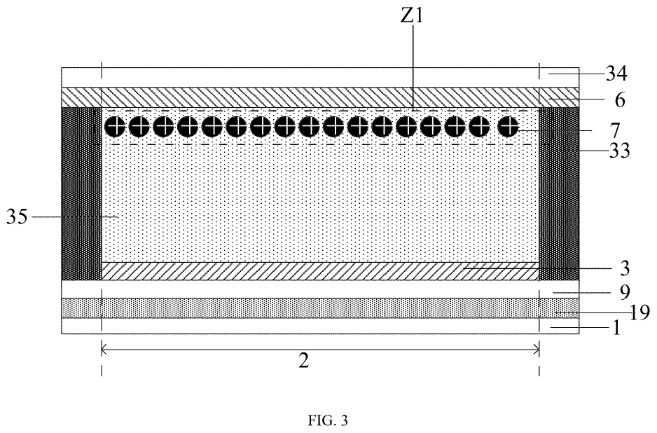

As shown in FIG. 3, the electronic paper display panel further includes a reflection layer 19 located between the first base substrate 1 and the electrophoretic liquid layer 35.

The electronic paper display panel provided by the embodiments of the disclosure includes the reflection layer, so that light can be reflected after reaching the reflection layer, thereby improving the reflectivity.

Exemplarily, light is incident from a side of the second base substrate facing away from the common electrode.

Exemplarily, the larger an area of the reflection layer blocked by black charged particles is, the lower the brightness of light output by a pixel(s) is; and the smaller the area of the reflection layer blocked by the black charged particles is, the higher the brightness of the light output by the pixel(s) is.

Exemplarily, in conjunction with FIGS. 1 to 3, the plurality of charged particles may be black charged particles, and the black charged particles are positively charged. The black charged particles move in response to a bias between the common electrode and the pixel electrode. When the voltage bias causes the black charged particles to move close to the top of the electrophoretic liquid layer (i.e., close to the common electrode), the black charged particles may enter the first area Z1 (for example, up to a depth of about 1 micron) and suppress total internal reflection (TIR). The depth of the first area Z1 may vary due to the wavelength of the incident light, the angle of the incident light, and the refractive index of the front sheet and the medium. The incident light may be absorbed by the black charged particles, thereby producing a black state or a dark state. In such cases, the electronic paper display panel may display a dark color or black. When the black charged particles move away from the first area Z1 (for example, by a reverse bias), the light may be reflected in a total internal reflection (TIR) manner. Thereby, a white state or a bright state is produced at one or more sub-pixels. The pixel electrode may be used to drive the black charged particles to enter or leave the first region Z1 to form a combination of the black states and the white states, thereby being used to generate images.

Exemplarily, the plurality of charged particles may also include black charged particles and white charged particles, which is not limited herein.

In some embodiments, as shown in FIG. 3, the reflection layer 19 is located between the first base substrate 1 and the pixel electrode 3.

In some embodiments, as shown in FIG. 3, the reflection layer 19 includes a metal material, and the electronic paper display panel further includes a first insulating layer 9 located between the reflection layer 19 and the pixel electrode 3.

In some embodiments, as shown in FIG. 1 to FIG. 3, the electronic paper display panel further includes a plurality of blocking dam structures 33. That is, the blocking dam structures are provided to prevent the charged particles from moving toward adjacent sub-pixels.

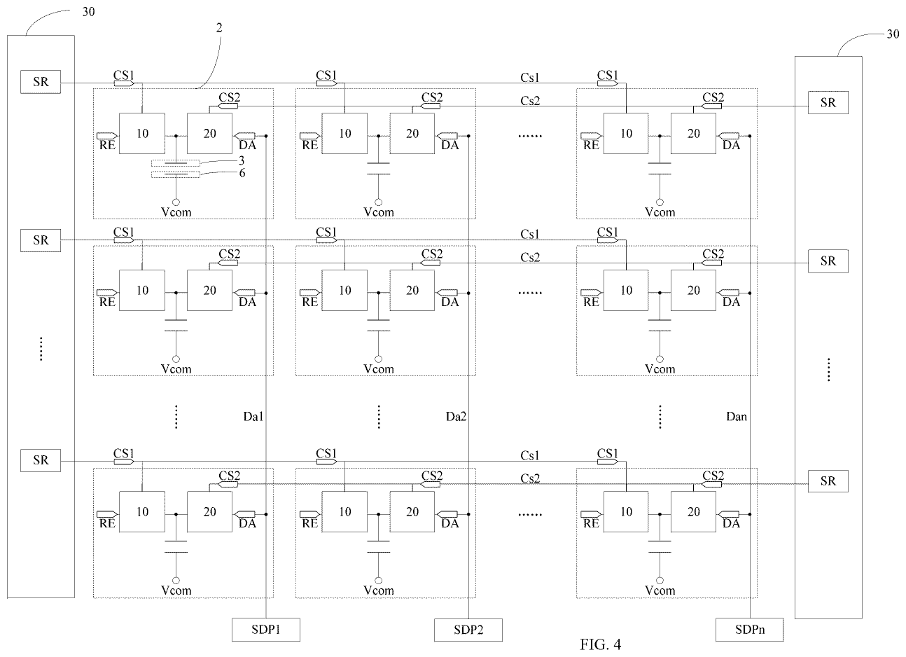

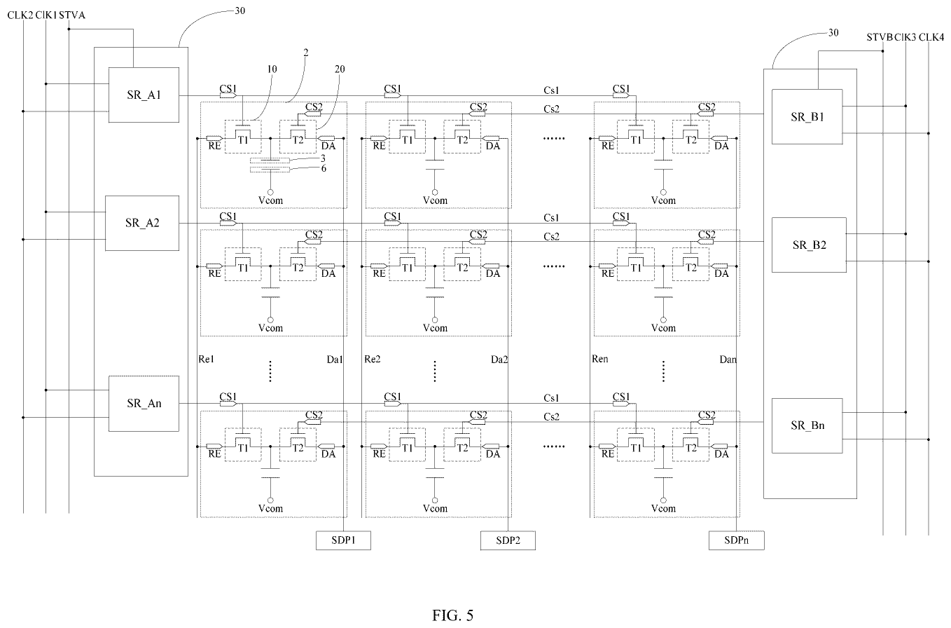

In the electronic paper display panel provided by the embodiments of the disclosure, as shown in FIG. 4, each of the plurality of sub-pixels 2 may further include: a first conduction circuit 10 and a second conduction circuit 20. In the same sub-pixel 2, the first conduction circuit 10 and the second conduction circuit 20 are both coupled to the pixel electrode 3. The first conduction circuit 10 is configured to provide a reset signal from a reset signal terminal RE to the pixel electrode 3 in response to a signal from a first control signal terminal CS1; and the second conduction circuit 20 is configured to provide a data signal from a data signal terminal DA to the pixel electrode 3 in respond to a signal from a second control signal terminal CS2. The first conduction circuit 10 and the second conduction circuit 20 in the same sub-pixel 2 work in a time-division manner.

In some embodiments of the disclosure, as shown in FIG. 4, the electronic paper display panel further includes: a gate driving circuit 30, including a plurality of shift registers SR. The first control signal terminal CS1 corresponding to the first conduction circuit 10 and the second control signal terminal CS2 corresponding to the second conduction circuit 20 in the same sub-pixel 2 are connected to different shift registers.

In the embodiments of the disclosure, the signal on the pixel electrode is controlled through the cooperation of the gate driving circuit, the first conduction circuit, and the second conduction circuit. The gate driving circuit controls the first conduction circuit and the second conduction circuit in the same sub-pixel to work in the time-division manner, which can reduce the use of Integrated Circuit (IC) chip and reduce production costs.

In some embodiments of the disclosure, as shown in FIG. 5, the first conduction circuit 10 includes: a first transistor T1. A gate of the first transistor T1 is coupled to the first control signal terminal CS1, a first electrode of the first transistor T1 is coupled to the reset signal terminal RE, and a second electrode of the first transistor T1 is coupled to the pixel electrode 3.

Exemplarily, the first transistor T1 can be turned on under the control of an effective level of a first control signal transmitted by the first control signal terminal CS1, and can be turned off under the control of an invalid level of the first control signal. For example, the first transistor T1 is set as a P-type transistor, then the effective level of the first control signal is a low level, and the invalid level of the first control signal is a high level. Alternatively, the first transistor T1 is set as an N-type transistor, then the effective level of the first control signal is a high level, and the invalid level of the first control signal is a low level.

In some embodiments of the disclosure, as shown in FIG. 5, the second conduction circuit 20 includes: a second transistor T2. A gate of the second transistor T2 is coupled to the second control signal terminal CS2, a first electrode of the second transistor T2 is coupled to the data signal terminal DA, and a second electrode of the second transistor T2 is coupled to the pixel electrode 3.

Exemplarily, the second transistor T2 can be turned on under the control of an effective level of a second control signal transmitted by the second control signal terminal CS2, and can be turned off under the control of an invalid level of the second control signal. Exemplarily, the second transistor T2 is set as a P-type transistor, then the effective level of the second control signal is a low level, and the invalid level of the second control signal is a high level. Alternatively, the second transistor T2 is set as an N-type transistor, then the effective level of the second control signal is a high level, and the invalid level of the second control signal is a low level.

In some embodiments of the disclosure, as shown in FIGS. 4 and 5, the electronic paper display panel further includes: a plurality of first scan signal lines Cs1 and a plurality of second scan signal lines Cs2. First control signal terminals CS1 corresponding to a row of sub-pixels 2 are all coupled to one of the plurality of first scan signal lines Cs1; second control signal terminals CS2 corresponding to a row of sub-pixels 2 are all coupled to one of the plurality of second scan signal lines Cs2.

In some embodiments of the disclosure, as shown in FIGS. 4 and 5, the plurality of shift registers SR include: a plurality of first shift registers (for example, SR_A1, SR_A2, SR_An in FIG. 5), and a plurality of second shift registers (for example, SR_B1, SR_B2, SR_Bn in FIG. 5); one first shift register (for example, SR_A1, SR_A2, or SR_An in FIG. 5) of the plurality of first shift registers (for example, SR_A1, SR_A2, SR_An in FIG. 5) is coupled to one of the plurality of first scan signal lines Cs1; one second shift register (for example, SR_B1, SR_B2, or SR_Bn in FIG. 5) of the plurality of second shift registers (for example, SR_B1, SR_B2, SR_Bn in FIG. 5) is coupled to one of the plurality of second scan signal lines Cs2.

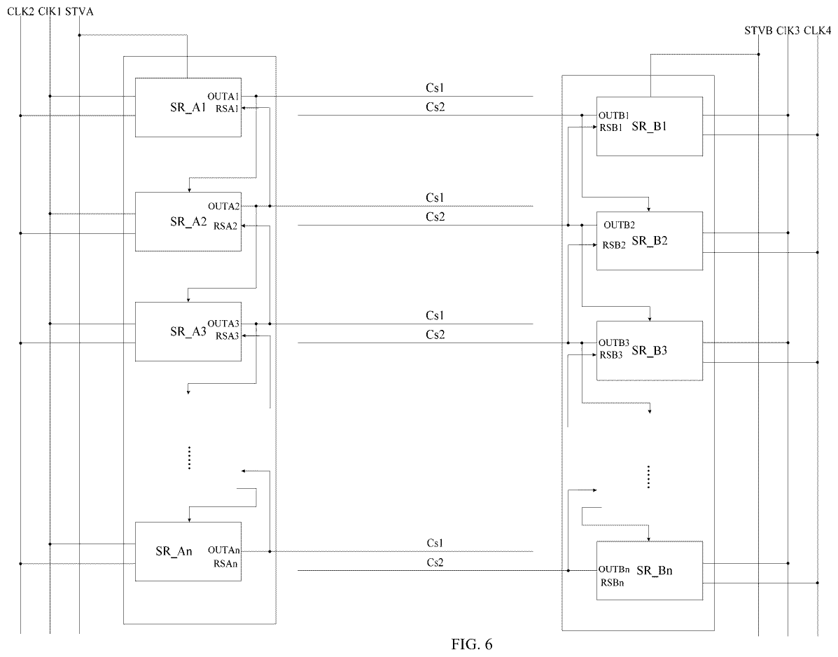

Exemplarily, as shown in FIG. 6, the electronic paper display panel further includes: trigger signal lines (e.g., STVA, STVB in FIG. 6), clock signal lines (e.g., CLK1, CLK2, CLK3, CLK4 in FIG. 6). The plurality of first shift registers (e.g., SR_A1, SR_A2, SR_A3, SR_An in FIG. 6) each includes an output signal terminal (e.g., OUTA1, OUTA2, OUTA3, OUTAn in FIG. 6), and a reset signal terminal (e.g., RSA1, RSA2, RSA3, RSAn in FIG. 6). The plurality of second shift registers (e.g., SR_B1, SR_B2, SR_B3, SR_Bn in FIG. 6) each includes an output signal terminal (e.g., OUTB1, OUTB2, OUTB3, OUTBn in FIG. 6), and a reset signal terminal (e.g., RSB1, RSB2, RSB3, RSBn in FIG. 6). The trigger signal of the first-stage shift register comes from a signal loaded on the trigger signal line, and a signal at the output signal end of the previous-stage shift register is used as the trigger signal of the next-stage shift register, and the signal at the output signal end of the next-stage shift register is used as the signal for the reset signal end of the previous-stage shift register. For example, the first shift register SR_A1 is coupled to the trigger signal line STVA, and the signal at the output signal end OUTA1 of the first shift register SR_A1 is used as the trigger signal of the first shift register SR_A2, and the signal at the output signal end OUTA2 of the first shift register SR_A2 is used as the signal for the reset signal end RSA1 of the first shift register SR_A1.

In some embodiments of the disclosure, as shown in FIG. 5, the electronic paper display panel further includes: a plurality of reset signal lines (for example, Re1, Re2, Ren in FIG. 5) and a plurality of data lines (for example, Da1, Da2, Dan in FIG. 5). The reset signal terminals RE corresponding to a column of sub-pixels 2 is coupled to one reset signal line (for example, Re1, Re2, or Ren in FIG. 5) of the plurality of reset signal lines (for example, Re1, Re2, Ren in FIG. 5); the data signal terminals DA corresponding to the column of sub-pixels 2 is coupled to one data line (for example, Da1, Da2, or Dan in FIG. 5) of the plurality of data lines (for example, Da1, Da2, Dan in FIG. 5).

Exemplarily, as shown in FIG. 5, the electronic paper display panel further includes a plurality of source driving input terminals (for example, SDP1, SDP2, SDPn in FIG. 5), and one data line (for example, Da1, Da2, or Dan in FIG. 5) of the plurality of data lines (for example, Da1, Da2, Dan in FIG. 5) is coupled to one source driving input terminal (for example, SDP1, SDP2, or SDPn in FIG. 5) of the plurality of source driving input terminals (for example, SDP1, SDP2, SDPn in FIG. 5).

For example, the first electrode of the transistor mentioned above may be its source, and the second electrode may be its drain. Alternatively, the first electrode may be its drain, and the second electrode may be its source. There is no limitation here.

Generally, a transistor using low temperature polysilicon (LTPS) as an active layer has high mobility and can be made thinner and smaller, with lower power consumption, etc. In a specific implementation, a material of the active layer of at least one transistor mentioned above may be set to low temperature polysilicon material. In this way, the transistors mentioned can be set to an LTPS transistor to have high mobility and can be made thinner and smaller, with lower power consumption, etc.

Generally, a transistor using metal oxide semiconductor materials as an active layer has a small leakage current. Therefore, in order to reduce the leakage current, in some embodiments of the disclosure, a material of the active layer of the at least one transistor mentioned may include a metal oxide semiconductor material, such as Indium Gallium Zinc Oxide (IGZO), or other metal oxide semiconductor materials, which are not limited here. In this way, the transistors mentioned above may be set as an oxide thin film transistor to reduce the leakage current.

Generally, amorphous silicon (a-Si) material can also be used as the active layer. In a specific implementation, the material of the active layer of the at least one transistor can be set to amorphous silicon, so that the transistors mentioned above can be set to a-Si type transistors.

For example, all transistors may be set as LTPS transistors. Alternatively, all transistors may be set as oxide transistors. Since metal oxides are relatively low in cost, there is no need to use laser equipment for crystallization. Alternatively, some transistors may be set as oxide transistors and the remaining transistors may be set as LTPS transistors. Alternatively, all transistors may be set as a-Si transistors.

Exemplarily, as shown in FIG. 4 and FIG. 5, a voltage applied to the common electrode 6 is a common electrode voltage Vcom. In practical applications, the specific value of the common electrode voltage Vcom can be designed and determined according to the actual application environment, and is not limited here.

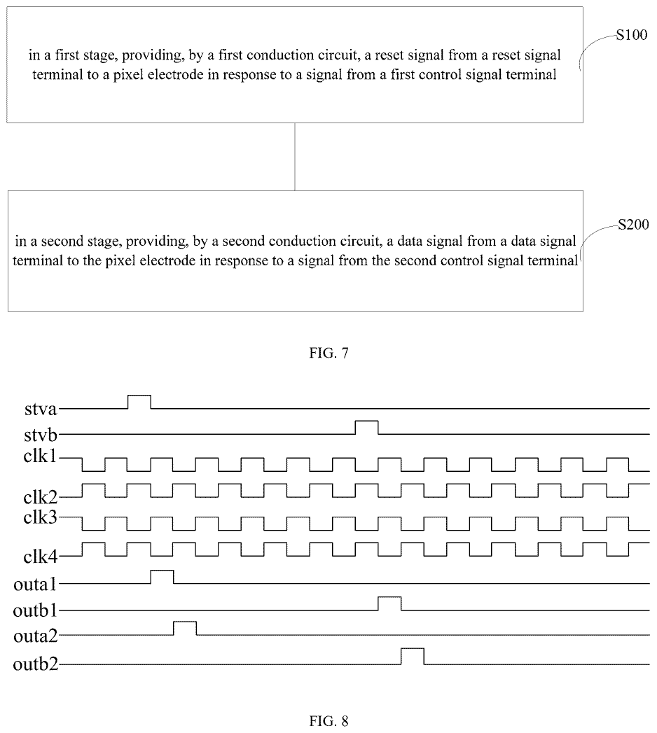

The method for driving of the electronic paper display panel provided by the embodiments of the disclosure, as shown in FIG. 7, includes:
S100, in a first stage, providing, by a first conduction circuit, a reset signal from a reset signal terminal to a pixel electrode in response to a signal from a first control signal terminal;
S200, in a second stage, providing, by a second conduction circuit, a data signal from a data signal terminal to the pixel electrode in response to a signal from the second control signal terminal.

The first conduction circuit and the second conduction circuit in the same sub-pixel work in a time-division manner.

In some embodiments of the disclosure, potentials of the reset signal and the data signal provided to the pixel electrode in the same sub-pixel are opposite with each other. For example, if the reset signal provided to the pixel electrode in the same sub-pixel is a high potential signal, the data signal is a low potential signal. Alternatively, if the reset signal provided to the pixel electrode in the same sub-pixel is a low potential signal, the data signal is a high potential signal. This is not limited here. By setting the potentials of the reset signal and the data signal provided to the pixel electrode in the same sub-pixel to be opposite with each other, DC balance can be achieved to prevent low potential accumulation or high potential accumulation in the pixel electrode.

In some embodiments of the disclosure, the potential of the reset signal provided to the pixel electrode in each sub-pixel is a fixed potential. In practical applications, the specific value of the potential of the reset signal may be designed and determined according to the actual application environment and is not limited here.

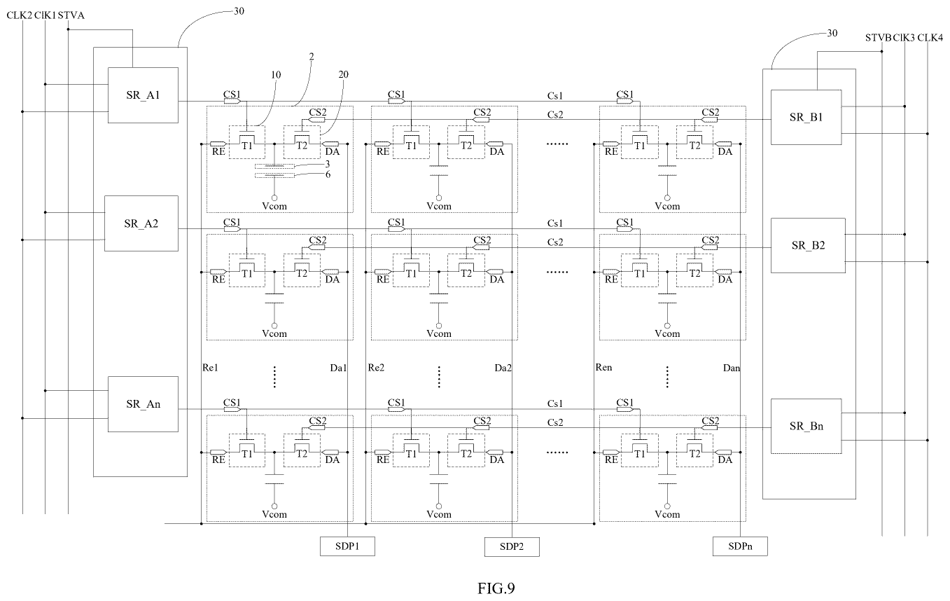

The following takes the electronic paper display panel shown in FIG. 5 as an example, and describes a working process of the electronic paper display panel provided by the embodiments of the disclosure in combination with a timing diagram of signals shown in FIG. 8.

As shown in FIG. 8, stva represents a trigger signal loaded on the trigger signal line STVA, stvb represents a trigger signal loaded on the trigger signal line STVB, clk1 represents a clock signal loaded on the clock signal line CLK1, clk2 represents a clock signal loaded on the clock signal line CLK2, clk3 represents a clock signal loaded on the clock signal line CLK3, clk4 represents a clock signal loaded on the clock signal line CLK4, outa1 represents a scan drive signal loaded on the output signal terminal OUTA1, outa2 represents a scan drive signal loaded on the output signal terminal OUTA2, outb1 represents a scan drive signal loaded on the output signal terminal OUTB1, and outb2 represents a scan drive signal loaded on the output signal terminal OUTB2.

In the first stage, a reset signal is input into the sub-pixels 2 controlled by the plurality of first shift registers (such as SR_A1, SR_A2, and SR_An in FIG. 5) in the gate driving circuit 30, thereby resetting the electronic paper display panel. Specifically, the first shift register SR_A1 of the plurality of first shift registers loads a scan drive signal to the first first scan signal line Cs1 of the plurality of first scan signal lines, and the second shift register SR_A2 of the plurality of first shift registers loads a scan drive signal to the second first scan signal line Cs1 of the plurality of first scan signal lines . . . the n^{th} shift register SR_An of the plurality of first shift registers loads a scan drive signal to the n^{th} first scan signal line Cs1 of the plurality of first scan signal lines. When a high level appears in the scan drive signals outa1 to outan, the first control signal terminal CS1 correspondingly coupled to the first scan signal line Cs1 can be controlled to load with a high level signal. The first transistor T1 is turned on under the control of the high level signal, and the reset signal of the reset signal terminal RE is provided to the pixel electrode 3.

In the second stage, a data signal is input into the sub-pixels 2 controlled by the plurality of second shift registers (such as SR_B1, SR_B2, SR_Bn in FIG. 5) in the gate driving circuit 30, thereby driving the electronic paper display panel to display a picture. Specifically, the first shift register SR_B1 of the plurality of second shift registers loads a scan drive signal to the first second scan signal line Cs2 of the plurality of second scan signal lines, the second shift register SR_B2 of the plurality of second shift registers loads a scan drive signal to the second second scan signal line Cs2 of the plurality of second scan signal lines . . . the n^{th} shift register SR Bn of the plurality of second shift registers loads a scan drive signal to the n^{th} second scan signal line Cs2 of the plurality of second scan signal lines. When a high level appears in the scan drive signals outb1 to outbn, the second control signal terminal CS2 correspondingly coupled to the second scan signal line Cs2 can be controlled to load with a high level signal. The second transistor T2 is turned on under the control of the high level signal, and the data signal of the data signal terminal DA is provided to the pixel electrode 3.

The embodiments of the disclosure provide another implementation of the electronic paper display panel, which is a modification of the implementations in the above embodiments. The following only describes the differences between this embodiment and the above embodiments, and the similarities are not repeated here.

In some other embodiments of the disclosure, as shown in FIG. 9, a plurality of reset signal lines (e.g., Re1, Re2, Ren in FIG. 9) are coupled with each other.

The embodiments of the disclosure provide another implementation of the electronic paper display panel, which is a modification of the implementations in the above embodiments. The following only describes the differences between this embodiment and the above embodiments, and the similarities are not repeated here.

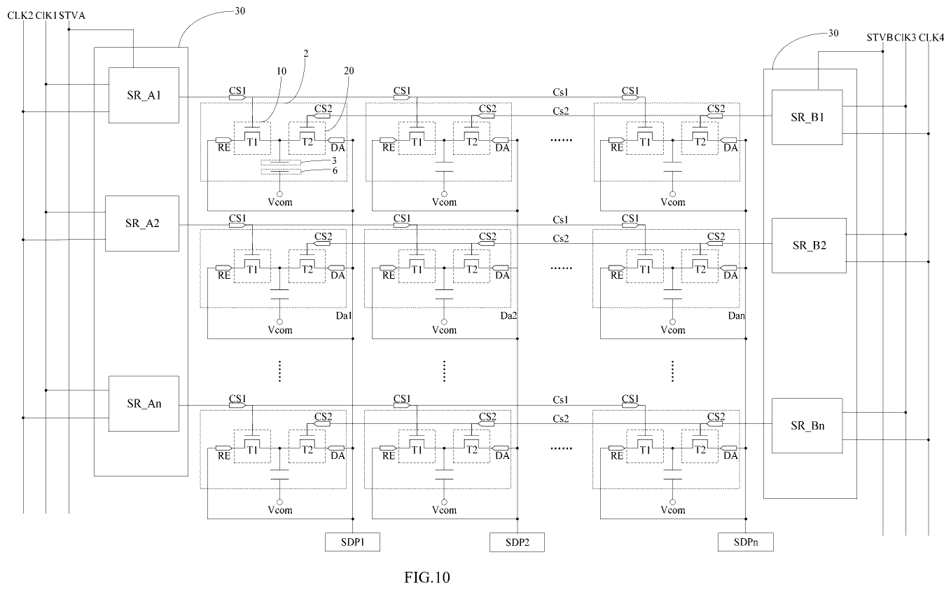

In some other embodiments of the disclosure, as shown in FIG. 10, the electronic paper display panel includes: a plurality of data lines (e.g., Da1, Da2, Dan in FIG. 10), a plurality of source driving input terminals (e.g., SDP1, SDP2, SDPn in FIG. 10); a column of sub-pixels 2 corresponds to one data line (e.g., Da1, Da2, or Dan in FIG. 10) of the plurality of data lines (e.g., Da1, Da2, Dan in FIG. 10) and one source driving input terminal (e.g., SDP1, SDP2, or SDPn in FIG. 10) of the plurality of source driving input terminals (e.g., SDP1, SDP2, SDPn in FIG. 10); data signal terminals DA corresponding to the column of sub-pixels 2 are coupled to the corresponding source driving input terminal (e.g., SDP1, SDP2, SDPn in FIG. 10) through the corresponding data line (e.g., Da1, Da2, Dan in FIG. 10). Reset signal terminals RE corresponding to sub-pixels 2 in the same column are coupled to a data line (e.g., Da1, Da2, Dan in FIG. 10) corresponding to the sub-pixels 2 in the same column.

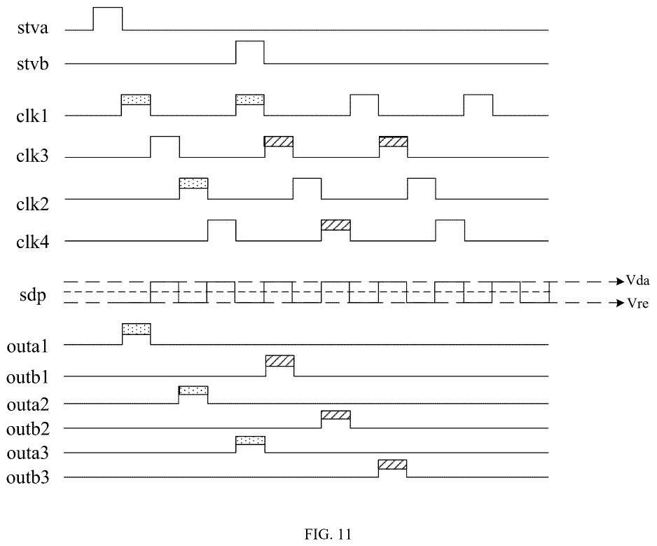

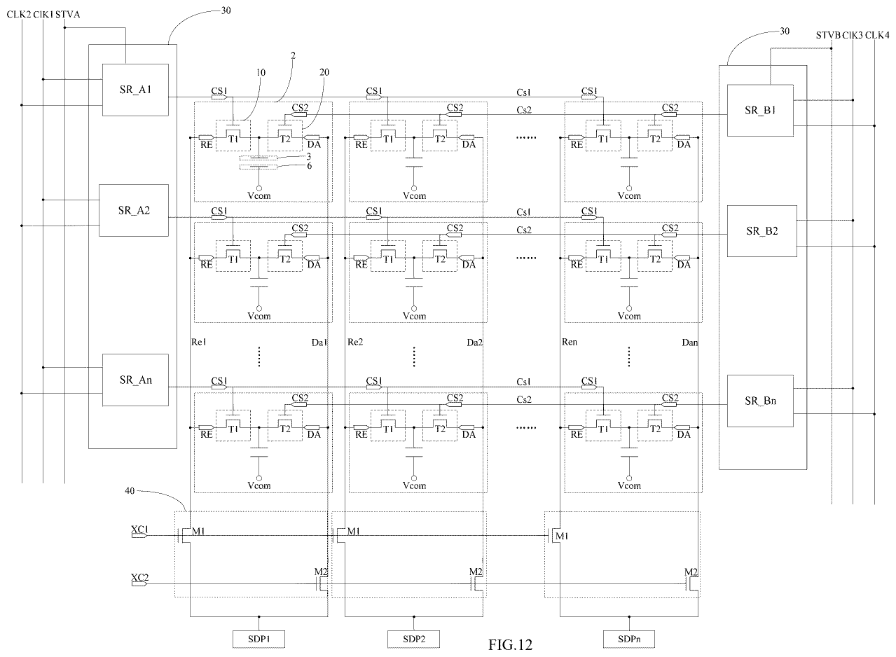

The following takes the electronic paper display panel shown in FIG. 10 as an example, and describes a working process of the electronic paper display panel provided by the embodiments of the disclosure in combination with a timing diagram of signals shown in FIG. 11.

As shown in FIG. 11, stva represents a trigger signal loaded on the trigger signal line STVA, stvb represents a trigger signal loaded on the trigger signal line STVB, clk1 represents a clock signal loaded on the clock signal line CLK1, clk2 represents a clock signal loaded on the clock signal line CLK2, clk3 represents a clock signal loaded on the clock signal line CLK3, clk4 represents a clock signal loaded on the clock signal line CLK4, outa1 represents a scan drive signal loaded on the output signal terminal OUTA1, outa2 represents a scan drive signal loaded on the output signal terminal OUTA2, outa3 represents a scan drive signal loaded on the output signal terminal OUTA3, outb1 represents a scan drive signal loaded on the output signal terminal OUTB1, outb2 represents a scan drive signal loaded on the output signal terminal OUTB2, outb3 represents a scan drive signal loaded on the output signal terminal OUTB3, sdp represents a signal loaded on the source driving input terminal. Vda represents a voltage of the data signal, and Vre represents a voltage of the reset signal.

In the first stage, a reset signal is input into the sub-pixels 2 controlled by the plurality of first shift registers (such as SR_A1, SR_A2, SR_An in FIG. 10) in the gate driving circuit 30, thereby resetting the electronic paper display panel. Specifically, the first shift register SR_A1 of the plurality of first shift registers loads a scan drive signal to the first first scan signal line Cs1 of the plurality of first scan signal lines, and the second shift register SR_A2 of the plurality of first shift registers loads a scan drive signal to the second first scan signal line Cs1 of the plurality of first scan signal lines . . . the n^{th} shift register SR_An of the plurality of first shift registers loads a scan drive signal to the n^{th} first scan signal line Cs1 of the plurality of first scan signal lines, and when a high level appears in the scan drive signals outa1 to outan, the first control signal terminal CS1 correspondingly coupled to the first scan signal line Cs1 can be controlled to load with a high level signal. The first transistor T1 is turned on under the control of the high level signal, and the reset signal of the reset signal terminal RE is provided to the pixel electrode 3.

In the second stage, a data signal is input into the sub-pixels 2 controlled by the plurality of second shift registers (such as SR_B1, SR_B2, SR_Bn in FIG. 10) in the gate driving circuit 30, thereby driving the electronic paper display panel to display a picture. Specifically, the first shift register SR_B1 in the plurality of second shift registers loads a scan drive signal to the first second scan signal line Cs2 of the plurality of second scan signal lines, and the second shift register SR_B2 of the plurality of second shift registers loads a scan drive signal to the second second scan signal line Cs2 of the plurality of second scan signal lines . . . the n^{th} shift register SR_Bn of the plurality of second shift registers loads a scan drive signal to the n^{th} second scan signal line Cs2 of the plurality of second scan signal lines. When a high level appears in the scan drive signals outb1 to outbn, the second control signal terminal CS2 correspondingly coupled to the first second scan signal line Cs2 of the plurality of second scan signal lines can be controlled to load with a high level signal. The second transistor T2 is turned on under the control of the high level signal, and the data signal of the data signal terminal DA is provided to the pixel electrode 3.

The embodiments of the disclosure provide another implementation of the electronic paper display panel, which is a modification of the implementations in the above embodiments. The following only describes the differences between this embodiment and the above embodiments, and the similarities are not repeated here.

In some other embodiments of the disclosure, as shown in FIG. 12, the electronic paper display panel further includes: a plurality of gating control circuits 40, and a plurality of source driving input terminals (for example, SDP1, SDP2, SDPn in FIG. 12). A column of sub-pixels 2 corresponds to one gating control circuit 40 of the plurality of gating control circuits 40 and one source driving input terminal (for example, SDP1, SDP2, or SDPn in FIG. 12) of the plurality of source driving input terminals (for example, SDP1, SDP2, SDPn in FIG. 12). The source driving input terminal (for example, SDP1, SDP2, SDPn in FIG. 12) is connected to a reset signal line (for example, Re1, Re2, and Ren in FIG. 12) and a data line (for example, Da1, Da2, Dan in FIG. 12) of a corresponding column of sub-pixels 2 through the corresponding gating control circuit 40. The gating control circuit 40 is configured to provide the signal of the source driving input terminal (e.g., SDP1, SDP2, SDPn in FIG. 12) to the corresponding reset signal line (e.g., Re1, Re2, Ren in FIG. 12) in response to a signal from a first gating control terminal XC1, and provide the signal of the source driving input terminal (e.g., SDP1, SDP2, SDPn in FIG. 12) to the corresponding data line (e.g., Da1, Da2, Dan in FIG. 12) in response to a signal from a second gating control terminal XC2.

In some other embodiments of the disclosure, as shown in FIG. 12, the gating control circuit 40 includes: a first gating control transistor M1 and a second gating control transistor M2. A gate of the first gating control transistor M1 is coupled to the first gating control terminal XC1, a first electrode of the first gating control transistor MI is coupled to the reset signal line (for example, Re1, Re2, Ren in FIG. 12), and a second electrode of the first gating control transistor M1 is coupled to the source driving input terminal (for example, SDP1, SDP2, SDPn in FIG. 12). A gate of the second gating control transistor M2 is coupled to the second gating control terminal XC2, a first electrode of the second gating control transistor M2 is coupled to the data line (for example, Da1, Da2, Dan in FIG. 12), and a second electrode of the second gating control transistor M2 is coupled to the source driving input terminal (for example, SDP1, SDP2, SDPn in FIG. 12).

Exemplarily, the first gating control transistor M1 can be turned on under the control of an effective level of the first gating control signal transmitted by the first gating control terminal XC1, and can be turned off under the control of an invalid level of the first gating control signal. Exemplarily, the first gating control transistor M1 is set as a P-type transistor, then the effective level of the first gating control signal is a low level, and the invalid level of the first gating control signal is a high level. Alternatively, the first gating control transistor M1 is set as an N-type transistor, then the effective level of the first gating control signal is a high level, and the invalid level of the first gating control signal is a low level.

Exemplarily, the second gating control transistor M2 can be turned on under the control of an effective level of the second gating control signal transmitted by the second gating control signal terminal XC2, and can be turned off under the control of an invalid level of the second gating control signal. Exemplarily, the second gating control transistor M2 is set as a P-type transistor, then the effective level of the second gating control signal is a low level, and the invalid level of the second gating control signal is a high level. Alternatively, the second gating control transistor M2 is set as an N-type transistor, then the effective level of the second gating control signal is a high level, and the invalid level of the second gating control signal is a low level.

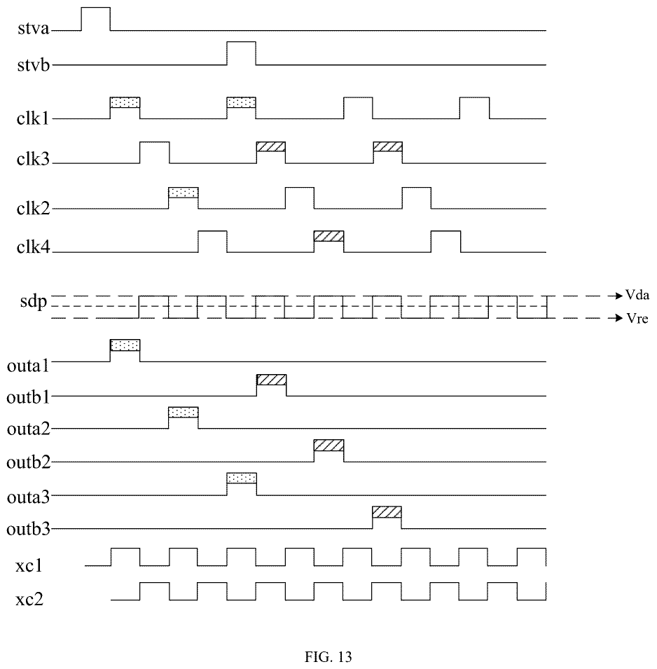

The following takes the electronic paper display panel shown in FIG. 12 as an example, and describes a working process of the electronic paper display panel provided by the embodiments of the disclosure in combination with a timing diagram of signals shown in FIG. 13.

As shown in FIG. 13, stva represents a trigger signal loaded on the trigger signal line STVA, stvb represents a trigger signal loaded on the trigger signal line STVB, clk1 represents a clock signal loaded on the clock signal line CLK1, clk2 represents a clock signal loaded on the clock signal line CLK2, clk3 represents a clock signal loaded on the clock signal line CLK3, clk4 represents a clock signal loaded on the clock signal line CLK4, outa1 represents a scan drive signal loaded on the output signal terminal OUTA1, outa2 represents a scan drive signal loaded on the output signal terminal OUTA2, and outa 3 represents a scan drive signal loaded on the output signal terminal OUTA3, outb1 represents a scan drive signal loaded on the output signal terminal OUTB1, outb2 represents a scan drive signal loaded on the output signal terminal OUTB2, outb3 represents a scan drive signal loaded on the output signal terminal OUTB3, sdp represents a signal loaded on the source driving input terminal. Vda represents a voltage of the data signal, Vre represents a voltage of the reset signal, xc1 represents a first gating control signal loaded on the first gating control terminal XC1, and xc2 represents a second gating control signal loaded on the second gating control terminal XC2.

In the first stage, a reset signal is input into the sub-pixels 2 controlled by the plurality of first shift registers (such as SR_A1, SR_A2, and SR_An in FIG. 12) in the gate driving circuit 30 inputs, thereby resetting the electronic paper display panel. Specifically, the first shift register SR_A1 of the plurality of first shift registers loads a scan drive signal to the first first scan signal line Cs1 of the plurality of first scan signal lines, the second shift register SR_A2 of the plurality of first shift registers loads a scan drive signal to the second first scan signal line Cs1 of the plurality of first scan signal lines . . . the n^{th} shift register SR_An of the plurality of first shift registers loads a scan drive signal to the n^{th} first scan signal line Cs1 of the plurality of first scan signal lines. When a high level appears in the scan drive signals outa1 to outan, the first control signal terminal CS1 correspondingly coupled to the first scan signal line Cs1 can be controlled to load with a high level signal. The first gating control transistor M1 is turned on under the control of the high level signal, and provides a signal of the source driving input terminal (such as SDP1, SDP2, SDPn in FIG. 12) to a corresponding reset signal line (such as Re1, Re2, Ren in FIG. 12). The first transistor T1 is turned on under the control of the high level signal, and provides the reset signal of the reset signal terminal RE to the pixel electrode 3.

In the second stage, a data signal is input into the sub-pixels 2 controlled by the plurality of second shift registers (such as SR_B1, SR_B2, SR_Bn in FIG. 12) in the gate driving circuit 30, thereby driving the electronic paper display panel to display a picture. Specifically, the first shift register SR_B1 of the plurality of second shift registers loads a scan drive signal to the first second scan signal line Cs2 of the plurality of second scan signal lines, the second shift register SR_B2 of the plurality of second shift registers loads a scan drive signal to the second second scan signal line Cs2 of the plurality of second scan signal lines . . . the n^{th} shift register SR_Bn of the plurality of second shift registers loads a scan drive signal to the n^{th} second scan signal line Cs2 of the plurality of second scan signal lines, and when a high level appears in the scan drive signals outb1 to outbn, the second control signal terminal CS2 correspondingly coupled to the second scan signal line Cs2 can be controlled to load with a high level signal. The second gating control transistor M2 is turned on under the control of the high level signal, and provides a signal of the source driving input terminal (such as SDP1, SDP2, SDPn in FIG. 12) to a corresponding data line (such as Da1, Da2, Dan in FIG. 12). The second transistor T2 is turned on under the control of the high level signal, and provides a data signal of the data signal terminal DA to the pixel electrode 3.

The embodiments of disclosure provide another implementation of the electronic paper display panel, which is a modification of the implementations in the above embodiments. The following only describes the differences between this embodiment and the above embodiments, and the similarities are not repeated here.

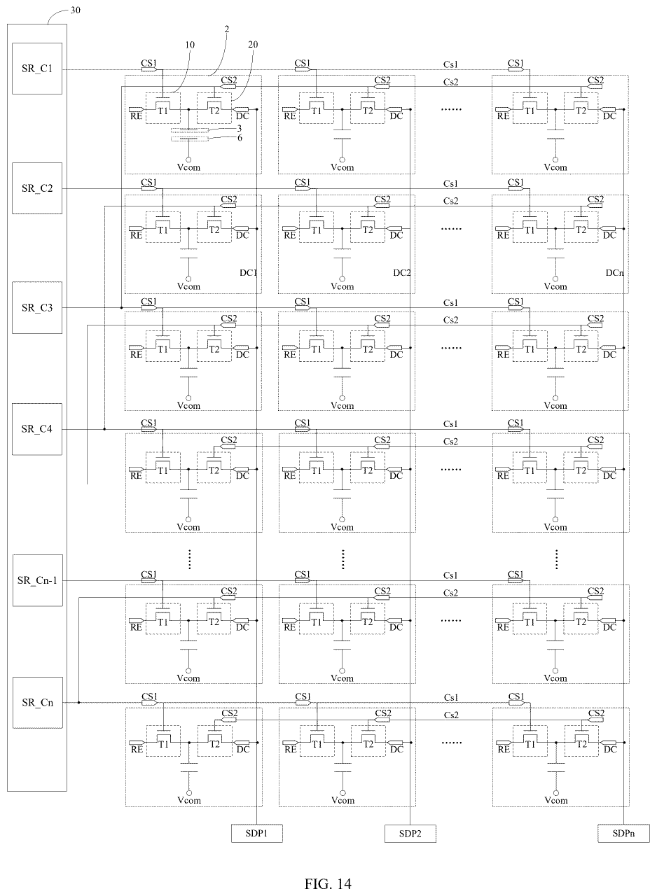

In some other embodiments of the disclosure, as shown in FIG. 14, the plurality of shift registers include: a plurality of third shift registers (for example, SR_C1, SR_C2, SR_Cn in FIG. 14). One third shift register (for example, SR_C1, SR_C2, or SR_Cn in FIG. 14) of the plurality of third shift registers (for example, SR_C1, SR_C2, SR_Cn in FIG. 14) is coupled to one first scan signal line Cs1 of the plurality of first scan signal lines Cs1; the first scan signal line Cs1 corresponding to the m^{th} row of sub-pixels 2 is coupled to the second scan signal line Cs2 corresponding to the n^{th} row of sub-pixels 2, m is greater than n; m and n are both positive integers. Exemplarily, the first scan signal line Cs1 corresponding to the third row of sub-pixels 2 is coupled to the second scan signal line Cs2 corresponding to the first row of sub-pixels 2, the first scan signal line Cs1 corresponding to the m^{th} row of sub-pixels 2 is coupled to the second scan signal line Cs2 corresponding to the n^{th} row of sub-pixels 2, the first scan signal line Cs1 corresponding to the fourth row of sub-pixels 2 is coupled to the second scan signal line Cs2 corresponding to the second row of sub-pixels 2, the first scan signal line Cs1 corresponding to the fifth row of sub-pixels 2 is coupled to the second scan signal line Cs2 corresponding to the third row of sub-pixels 2 . . . and the connection method of the remaining scan signal lines can be inferred accordingly and will not be elaborated here.

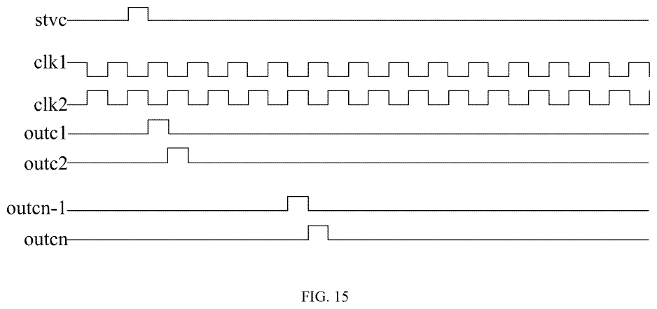

The following takes the electronic paper display panel shown in FIG. 14 as an example, and describes a working process of the electronic paper display panel provided by the embodiments of the disclosure in combination with a timing diagram of signals shown in FIG. 15.

As shown in FIG. 15, stvc represents a trigger signal loaded on the trigger signal line STVC, clk1 represents a clock signal loaded on the clock signal line CLK1, clk2 represents a clock signal loaded on the clock signal line CLK2, outc1 represents a scan drive signal loaded on the output signal terminal OUTC1, outc2 represents a scan drive signal loaded on the output signal terminal OUTC2, outcn−1 represents a scan drive signal loaded on the output signal terminal OUTCn−1, and outcn represents a scan drive signal loaded on the output signal terminal OUTCn.

In the first stage, a reset signal is input into the sub-pixels 2 controlled by the plurality of third shift registers (such as SR_C1, SR_C2, SR_Cn in FIG. 14) in the gate driving circuit 30, thereby resetting the electronic paper display panel. Specifically, the first shift register SR_C1 of the plurality of third shift registers loads a scan drive signal to the first first scan signal line Cs1 of the plurality of first scan signal lines, the second shift register SR_C2 of the plurality of third shift registers loads a scan drive signal to the second first scan signal line Cs1 of the plurality of first scan signal lines . . . the n^{th} shift register SR_Cn of the plurality of third shift registers loads a scan drive signal to the n^{th} first scan signal line Cs1 in the plurality of first scan signal lines, and when a high level appears in the scan drive signals outc1 to outcn, the first control signal terminal CS1 correspondingly coupled to the first scan signal line Cs1 can be controlled to load with a high level signal. The first transistor T1 is turned on under the control of the high level signal, and the reset signal of the reset signal terminal RE is provided to the pixel electrode 3.

In the second stage, a data signal is input into the sub-pixels 2 controlled by the plurality of third shift registers (e.g., SR_C1, SR_C2, SR_Cn in FIG. 14) in the gate driving circuit 30, thereby driving the electronic paper display panel to display a picture. Specifically, the third shift register SR_C3 of the plurality of third shift registers loads a scan drive signal to the first second scan signal line Cs2 of the plurality of second scan signal lines, the fourth shift register SR_C4 of the plurality of third shift registers loads a scan drive signal to the second second scan signal line Cs2 of the plurality of second scan signal lines, the fifth shift register SR_C5 of the plurality of third shift registers loads a scan drive signal to the third second scan signal line Cs2 of the plurality of second scan signal lines, . . . the n^{th} shift register SR_Cn of the plurality of third shift registers loads a scan drive signal to the (n−2)^{th} second scan signal line Cs2 of the plurality of second scan signal lines, and when a high level appears in the scan drive signals outc1 to outcn, the second control signal terminal CS2 correspondingly coupled to the second scan signal line Cs2 can be controlled to load with a high level signal. The second transistor T2 is turned on under the control of the high level signal, and the data signal of the data signal terminal DA is provided to the pixel electrode 3.

Based on the same disclosed concept, the embodiments of the disclosure also provide a display apparatus, including the electronic paper display panel provided by the embodiments of the disclosure. The principle of the display apparatus solving the problem is similar to that of the electronic paper display panel, so the implementation of the display apparatus can refer to the implementation of the electronic paper display panel, and repetitions will be omitted.

In a specific implementation, in the embodiments of the disclosure, the display apparatus may be any product or component with a display function, such as a mobile phone, a tablet computer, a television, a monitor, a laptop computer, a digital photo frame, a navigator, etc. Other essential components of the display apparatus are well understood by ordinary technicians in the field, and are not described here in detail, nor should they be used as limitations to the disclosure.

Although the preferred embodiments of the disclosure have been described, those skilled in the art can make various changes and modifications to the embodiments once the basic inventive concept is appreciated. Therefore, the appended claims are intended to be interpreted as including the preferred embodiments and all changes and modifications falling within the scope of the disclosure.

Apparently, those skilled in the art can make various changes and modifications to the embodiments of the disclosure without departing from the spirit and scope of the embodiments of the disclosure. In this way, if the modifications and variations of the embodiments of the disclosure fall within the scope of the claims of the disclosure and their equivalent technologies, the disclosure also intends to include these modifications and variations.

1. An electronic paper display panel, comprising:
a plurality of sub-pixels; wherein
each of the plurality of sub-pixels comprises: a first conduction circuit, a second conduction circuit, and a pixel electrode;
in a same sub-pixel, the first conduction circuit and the second conduction circuit are both coupled to the pixel electrode;
the first conduction circuit is configured to provide a reset signal from a reset signal terminal to the pixel electrode in response to a signal from a first control signal terminal;
the second conduction circuit is configured to provide a data signal from a data signal terminal to the pixel electrode in response to a signal from a second control signal terminal; and
the first conduction circuit and the second conduction circuit in the same sub-pixel work in a time-division manner; and
a gate driving circuit, comprising a plurality of shift registers; wherein the first control signal terminal corresponding to the first conduction circuit and the second control signal terminal corresponding to the second conduction circuit in the same sub-pixel are connected to different shift registers.

2. The electronic paper display panel according to claim 1, wherein
the first conduction circuit comprises a first transistor;
a gate of the first transistor is coupled to the first control signal terminal, a first electrode of the first transistor is coupled to the reset signal terminal, and a second electrode of the first transistor is coupled to the pixel electrode.

3. The electronic paper display panel according to claim 1, wherein
the second conduction circuit comprises a second transistor;
a gate of the second transistor is coupled to the second control signal terminal, a first electrode of the second transistor is coupled to the data signal terminal, and a second electrode of the second transistor is coupled to the pixel electrode.

4. The electronic paper display panel according to claim 1, further comprising:
a plurality of first scan signal lines and a plurality of second scan signal lines;
wherein, first control signal terminals corresponding to a row of sub-pixels are all coupled to one of the plurality of first scan signal lines; and
second control signal terminals corresponding to the row of sub-pixels are all coupled to one of the plurality of second scan signal lines.

5. The electronic paper display panel according to claim 4, wherein,
the plurality of shift registers comprises: a plurality of first shift registers and a plurality of second shift registers;
one of the plurality of first shift registers is coupled to one of the plurality of first scan signal lines;
one of the plurality of second shift registers is coupled to one of the plurality of second scan signal lines.

6. The electronic paper display panel according to claim 4, wherein,
the plurality of shift registers comprises: a plurality of third shift registers;
one of the plurality of third shift registers is coupled to one of the plurality of first scan signal lines;
the first scan signal line corresponding to the m^{th} row of sub-pixels is coupled to the second scan signal line corresponding to the n^{th} row of sub-pixels, wherein m is greater than n; and both m and n are positive integers.

7. The electronic paper display panel according to claim 1, further comprising:
a plurality of reset signal lines and a plurality of data lines;
reset signal terminals corresponding to a column of sub-pixels are coupled to one of the plurality of reset signal lines;
data signal terminals corresponding to the column of sub-pixels are coupled to one of the plurality of data lines.

8. The electronic paper display panel according to claim 7, further comprising:
a plurality of gating control circuits and a plurality of source driving input terminals;
wherein, the column of sub-pixels corresponds to one gating control circuit of the plurality of gating control circuits and one source driving input terminal of the plurality of source driving input terminals;
the source driving input terminal is coupled to the reset signal line and the data line of the corresponding column of sub-pixels through the gating control circuit, and the gating control circuit is configured to provide a signal from the source driving input terminal to the reset signal line in response to a signal from a first gating control terminal, and to provide the signal from the source driving input terminal to the data line in response to a signal from a second gating control terminal.

9. The electronic paper display panel according to claim 8, wherein,
the gating control circuit comprises: a first gating control transistor and a second gating control transistor;
a gate of the first gating control transistor is coupled to the first gating control terminal, a first electrode of the first gating control transistor is coupled to the reset signal line, and a second electrode of the first gating control transistor is coupled to the source driving input terminal;
a gate of the second gating control transistor is coupled to the second gating control terminal, a first electrode of the second gating control transistor is coupled to the data line, and a second electrode of the second gating control transistor is coupled to the source driving input terminal.

10. The electronic paper display panel according to claim 7, wherein the plurality of reset signal lines are coupled with each other.

11. The electronic paper display panel according to claim 1, further comprising:
a plurality of data lines and a plurality of source driving input terminals; wherein
a column of sub-pixels corresponds to one of the plurality of data lines and one of the plurality of source driving input terminals;
data signal terminals corresponding to the column of sub-pixels are coupled to the source driving input terminal through the data line.

12. The electronic paper display panel according to claim 1, further comprising: a first base substrate; wherein
the plurality of sub-pixels are located at a side of the first base substrate;
each of the plurality of sub-pixels further comprises:
a common electrode, located at a side of the pixel electrode facing away from the first base substrate; and
an electrophoretic liquid layer, located between the pixel electrode and the common electrode, and the electrophoretic liquid layer comprising a plurality of charged particles;
wherein the pixel electrode is configured to drive the plurality of charged particles to adjust grayscale display.

13. A display apparatus, comprising the electronic paper display panel according to claim 1.

14. A method for driving the electronic paper display panel according to claim 1, comprising:
in a first stage, in response to the signal from the first control signal terminal, providing, by the first conduction circuit, the reset signal from the reset signal terminal to the pixel electrode;
in a second stage, in response to the signal from the second control signal terminal, providing, by the second conduction circuit, the data signal from the data signal terminal to the pixel electrode.

15. The driving method of the electronic paper display panel according to claim 14, wherein potentials of the reset signal and the data signal provided to the pixel electrode in the same sub-pixel are opposite to each other.

16. The driving method of the electronic paper display panel according to claim 14, wherein the potential of the reset signal provided to the pixel electrode in each of the sub-pixels is a fixed potential.
